(19) United States
(12) Patent Application Publication
(10) Pub. No.: US 2013/0101932 A1
(43) Pub. Date: Apr. 25, 2013

(54) ELECTROPHOTOGRAPHIC TONER

(71) Applicant: TOSHIBA TEC KABUSHIKI KAISHA, Tokyo (JP)

(72) Inventor: Toshiaki Yamauchi, Kanagawa-ken (JP)

(73) Assignee: TOSHIBA TEC KABUSHIKI KAISHA, Tokyo (JP)

(21) Appl. No.: 13/653,492

(22) Filed: Oct. 17, 2012

Related U.S. Application Data
(60) Provisional application No. 61/549,330, filed on Oct. 20, 2011.

(51) Int. Cl. G03G 9/087; G03G 9/09

(52) U.S. Cl. 430/105

(57) ABSTRACT

Provided is an electrophotographic toner which can be decolorized, including: toner particles containing a binder resin, a color-forming compound, and a developer; and a cellulose fiber which is contained in the toner particles or is attached to the toner particles.

### CROSS-REFERENCE TO RELATED APPLICATION

This application is also based upon and claims the benefit of priority from U.S. provisional application 61/549330, filed on Oct. 20, 2011; the entire contents of which are incorporated herein by reference.

### FIELD

Embodiments described herein relate to a technology regarding an electrophotographic toner.

### BACKGROUND

Conventionally, in the case where an image is formed in an electrophotographic process, a toner, configured by dispersing a colorant such as a pigment in a binder resin and pulverizing the obtained product so as to have a particle size of approximately 4 to 20 μm in a uniform manner, is used as a unit of a pixel. In recent years, it has been proposed that a heat-decolorizable colorant is used in a toner, for the purpose of effective utilization of resources and reduction of carbon dioxide emissions. In the case that a toner is used for printing, an image formed on a sheet of paper can be erased by performing heating treatment on the printed sheet of paper. This enables a sheet of paper to be repeatedly used, thereby reducing an amount of paper resources to be used and reducing an energy for performing a deinking treatment on a sheet of paper.

However, even after a toner is decolorized by heating, a toner component such as a binder resin contained in the toner is remained on a sheet of paper. By repeating a printing treatment and a decolorizing treatment, a residual amount of a toner component on a sheet of paper increases. As the residual amount of a toner component on a sheet of paper increases in this manner, an erased image becomes recognizable due to the difference in light reflection characteristics between a melted resin on a sheet of paper and the sheet of paper.

### DETAILED DESCRIPTION

An electrophotographic toner according to the embodiment (hereinafter, also simply referred to as a toner) is decolorizable, and includes toner particles containing a binder resin, a color-forming compound, and a developer. Furthermore, the toner according to the embodiment includes a cellulose fiber which is contained in a toner particle or attached to a toner particle.

Embodiments will be described below. In the following description, a state in which a printing treatment and a decolorizing treatment are performed on a sheet of paper multiple times is referred to as repeated utilization of a sheet of paper.

The cellulose fiber contained in the toner according to the embodiment is made up of cellulose, which belongs to polysaccharides and is contained much in natural plants. By containing the cellulose fiber, affinity between a toner and a sheet of paper during image formation can be improved, and gloss produced when a binder resin is melted can be inhibited. Therefore, the boundary between a sheet of paper and a toner component remained on the sheet of paper can be made difficult to be recognized. For this reason, even after a sheet of paper is repeatedly utilized, an erased image is difficult to be recognized. As a result, the number of times a sheet of paper can be recycled may be increased.

In the embodiment, according to one aspect, the cellulose fiber may be contained in a toner particle. Alternatively, according to another aspect, the cellulose fiber may be attached to a toner particle. In view of fixing stability, it is preferable that the cellulose fiber be contained in a toner particle.

Although a method for manufacturing the cellulose fiber is not particularly limited, the cellulose fiber may be manufactured by, for example, using a pulp used in the manufacture of paper and the like as a material. Examples of the pulp may include a wood pulp obtained by extracting a fiber component from wood chips. Also, a non-wood pulp, such as a bagasse pulp which uses sugar cane as a raw material, and a straw pulp which uses wheat straw or rice straw as a raw material, may be used. Furthermore, a used paper pulp which uses recycled paper as a raw material can be used.

The size of a cellulose fiber contained in a toner is preferably equal to or larger than 0.1 μm and equal to or smaller than 10 μm. When the size is smaller than 0.1 μm, the effect that the boundary between a sheet of paper and a toner component becomes difficult to be recognized is reduced, as compared to the case in which the size is equal to or larger than 0.1 μm. Also, when the size is larger than 10 μm, as compared to the case in which the size is equal to or smaller than 10 μm, the cellulose fiber becomes difficult to be introduced in the toner particle.

As used herein, the size of a cellulose fiber refers to an average value of the length in a major axis direction (the long diameter) of a fiber. The size of a cellulose fiber can be measured using, for example, a scanning electron microscope (SEM).

Also, with respect to the cellulose fiber contained in a toner, existence of the cellulose fiber in a toner can be detected also by, for example, chemical analysis using an infrared spectrophotometer (IR).

The size of a cellulose fiber when it is added for manufacturing a toner is not particularly limited, and may be appropriately determined by those skilled in the art. For example, a cellulose fiber obtained by pulverizing pulp or the like to a size approximately equal to or smaller than that of a toner particle may be used. On the other hand, in the case that a kneading and pulverizing process is included in a toner manufacturing process, a cellulose fiber larger than a toner particle can be used.

To obtain a minute cellulose fiber, a pulp material may be miniaturized using, for example, a pulverizer such as a homogenizer. Also, a paper dust produced by, for example, cutting paper, as well as a powdered pulp which is used as a raw material of a cellulose ether for industrial purposes, and a paper dust also used as painting materials, may be utilized as the cellulose fiber according to the embodiment.

The ratio of a cellulose fiber in an entire toner is not particularly limited, and may be appropriately determined by those skilled in the art. However, the ratio is preferably equal to or higher than 3% by mass, more preferably equal to or higher than 15% by mass, further preferable equal to or higher than 30% by mass.

When the ratio of a cellulose fiber in an entire toner is lower than 3% by mass, the effect that the boundary between a sheet of paper and a toner component becomes difficult to be recognized is reduced, as compared to the case that the ratio is equal to or higher than 3% by mass. Although the upper limit of the content of a cellulose fiber is not particularly limited, it is preferable that the upper limit be lower than 50%, in view of fixing properties, toner's charging characteristics under high humidity, and the like.

The toner according to the embodiment contains a binder resin, a color-forming compound as a colorant, and a developer in a toner particle. The ratio of a toner component contained in the toner may be appropriately determined by those skilled in the art, and not particularly limited.

A type of the binder resin is not particularly limited. However, for example, polyester resin, polystyrene resin, styrene/ acrylate copolymer resin, polyester-styrene/acrylate hybrid resin, epoxy resin, and polyether polyol resin can be used.

The color-forming compound and the developer contained in the toner according to the embodiment are not particularly limited, as long as they have a mechanism in which decolorization is caused by heating to thereby increase the temperature and recoloring is caused by cooling. Examples of the color-forming compound may include a leuco dye, which can be used in combination with a developer. Furthermore, the color-forming compound can be used appropriately in combination with a decolorizing agent, a discoloration-temperature regulator, and the like. For example, a structure in which decolorization is caused at a temperature equal to or higher than a certain temperature and recoloring is caused at a temperature equal to or lower than a certain temperature may be selected.

A leuco dye is an electron-donating compound capable of color development by a developer. Examples of the leuco dye may include diphenylmethane phthalides, phenylindolyl phthalides, indolyl phthalides, diphenylmethane azaphthalides, phenylindolyl azaphthalides, fluorans, styrynoquinolines, and diazarhodamine lactones.

Specific examples of the leuco dye may include
3,3-bis(p-dimethylaminophenyl)-6-dimethylaminophthalide,
3-(4-diethylaminophenyl)-3-(1-ethyl-2-methylindole-3-yl)pht halide, 3,3-bis(1-n-butyl-2-methylindole-3-yl)phthalide,
3,3-bis(2-ethoxy-4-diethylaminophenyl)-4-azaphthalide,
3-(2-ethoxy-4-diethylaminophenyl)-3-(1-ethyl-2-methylindole-3-yl)-4-azaphthalide,
3-[2-ethoxy-4-(N-ethylanilino)phenyl]-3-(1-ethyl-2-methylin dole-3-yl)-4-azaphthalide, 3,6-diphenylaminofluoran,
3,6-dimethoxyfluoran, 3,6-di-n-butoxyfluoran,
2-methyl-6-(N-ethyl-N-p-tolylamino)fluoran,
2-N,N-dibenzylamino-6-diethylaminofluoran,
3-chloro-6-cyclohexylaminofluoran,
2-methyl-6-cyclohexylaminofluoran,
2-(2-chloroanilino)-6-di-n-butylaminofluoran,
2-(3-trifluoromethylanilino)-6-diethylaminofluoran,
2-(N-methylanilino)-6-(N-ethyl-N-p-tolylamino)fluoran,
1,3-dimethyl-6-diethylaminofluoran,
2-chloro-3-methyl-6-diethylaminofluoran,
2-anilino-3-methyl-6-diethylaminofluoran,
2-anilino-3-methyl-6-di-n-butylaminofluoran,
2-xylidino-3-methyl-6-diethylaminofluoran,
1,2-benz-6-diethylaminofluoran,
1,2-benz-6-(N-ethyl-N-isobutylamino)fluoran,
1,2-benz-6-(N-ethyl-N-isoamylamino)fluoran,
2-(3-methoxy-4-dodecoxystyryl)quinoline, spiro[5H-(1)benzopyrano(2,3-d)pyrimidine-5,1′(3′H)isobenzof uran]-3′-one, 2-(diethylamino)-8-(diethylamino)-4-methyl-, spiro[5H-(1)benzopyrano(2,3-d)pyrimidine-5,1′(3′H)isobenzof uran]-3′-one,
2-(di-n-butylamino)-8-(di-n-butylamino)-4-methyl-, spiro[5H-(1)benzopyrano(2,3-d)pyrimidine-5,1′(3′H)isobenzof uran]-3′-one,2-di-n-butylamino)-8-(diethylamino)-4-methyl-, spiro[5H-(1)benzopyrano(2,3-d)pyrimidine-5,1′(3′H)isobenzof uran]-3′-one,2-(di-n-butylamino)-8-(N-ethyl-N-i-amylamino)-4-methyl-,
spiro[5H-(1)benzopyrano(2,3-d)pyrimidine-5,1′(3′H)isobenzof uran]-3′-one,2-(di-n-butylamino)-8-(di-n-butylamino)-4-phen yl,
3-(2-methoxy-4-dimethylaminophenyl)-3-(1-butyl-2-methylindo le-3-yl)-4,5,6,7-tetrachlorophthalide,
3-(2-ethoxy-4-diethylaminophenyl)-3-(1-ethyl-2-methylindole-3-yl)-4,5,6,7-tetrachlorophthalide, and
3-(2-ethoxy-4-diethylaminophenyl)-3-(1-pentyl-2-methylindol e-3-yl)-4,5,6,7-tetrachlorophthalide. Furthermore, as a leuco dye, pyridine-based compounds, quinazoline-based compounds, bisquinazoline-based compounds, and the like may also be included. These may be used as a mixture of two or more.

A developer is an electron-accepting compound which provides a proton to a leuco dye. Examples of the developer may include phenols, phenol metal salts, metal carboxylates, aromatic carboxylic acid and aliphatic carboxylic acid having 2 to 5 carbons, benzophenones, sulfonic acid, sulfonic acid salt, phosphoric acids, phosphoric acid metal salts, acidic phosphoric acid ester, acidic phosphoric acid ester metal salts, phosphorous acids, phosphorous acid metal salts, monophenols, polyphenols, 1,2,3-triazole and derivative thereof. Furthermore, a compound having as its substituent an alkyl group, an aryl group, an acyl group, an alkoxycarbonyl group, a carboxy group and esters thereof or an amide group, a halogen group, and the like may be exemplified. Bis-type phenol, tris-type phenol, and the like; a phenol-aldehyde condensation resin and the like; and metal salts thereof may be included. These may be used as a mixture of two or more.

Specific examples of the developer may include phenol, o-cresol, tert-butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid or esters thereof, for example, 2,3-dihydroxybenzoic acid and methyl 3,5-dihydroxybenzoate, resorcin, gallic acid, dodecyl gallate, ethyl gallate, butyl gallate, propyl gallate, 2,2-bis(4-hydroxyphenyl)propane,
4,4-dihydroxydiphenylsulfone,
1,1-bis(4-hydroxyphenyl)ethane,
2,2-bis(4-hydroxy-3-methylphenyl)propane,
bis(4-hydroxyphenyl)sulfide,
1-phenyl-1,1-bis(4-hydroxyphenyl)ethane,
1,1-bis(4-hydroxyphenyl)-3-methylbutane,
1,1-bis(4-hydroxyphenyl)-2-methylpropane,
1,1-bis(4-hydroxyphenyl)n-hexane,
1,1-bis(4-hydroxyphenyl)n-heptane,
1,1-bis(4-hydroxyphenyl)n-octane,
1,1-bis(4-hydroxyphenyl)n-nonane,
1,1-bis(4-hydroxyphenyl)n-decane,
1,1-bis(4-hydroxyphenyl)n-dodecane,
2,2-bis(4-hydroxyphenyl)butane,
2,2-bis(4-hydroxyphenyl)ethylpropionate,
2,2-bis(4-hydroxyphenyl)-4-methylpentane,
2,2-bis(4-hydroxyphenyl)hexafluoropropane,
2,2-bis(4-hydroxyphenyl)n-heptane,
2,2-bis(4-hydroxyphenyl)n-nonane, 2,4-dihydroxyacetophenone,
2,5-dihydroxyacetophenone, 2,6-dihydroxyacetophenone,
3,5-dihydroxyacetophenone, 2,3,4-trihydroxyacetophenone,
2,4-dihydroxybenzophenone, 4,4′-dihydroxybenzophenone,
2,3,4-trihydroxybenzophenone, 2,4,4′-trihydroxybenzophenone,
2,2′,4,4′-tetrahydroxybenzophenone,
2,3,4,4′-tetrahydroxybenzophenone, 2,4′-biphenol,
4,4′-biphenol,
4-[(4-hydroxyphenyl)methyl]-1,2,3-benzenetriol,
4-[(3,5-dimethyl-4-hydroxyphenyl)methyl]-1,2,3-benzenetriol, 4,6-bis
[(3,5-dimethyl-4-hydroxyphenyl)methyl]-1,2,3-benzenetriol,
4,4′-[1,4-phenylenebis(1-methylethylidene)bis(benzene-1,2,3-triol)],
4,4′-[1,4-phenylenebis(1-methylethylidene)bis(1,2-benzenediol)], 4,4′,4″-ethylidenetrisphenol,
4,4′-(1-methylethylidene)bisphenol, and methylenetris-p-cresol.

The decolorizing agent may be a known decolorizing agent, as long as the decolorizing agent inhibits a color development reaction between a leuco dye and a developer due to heat so as to become colorless, in a three component system of a color-forming compound, a developer and a decolorizing agent.

With respect to the decolorizing agent, a color developing-decolorizing mechanism utilizing the temperature hysteresis of a decolorizing agent, which is known by JP60-264285, JP2005-1369, JP2008-280523, and the like, has excellent instantaneous erasability. By heating the color-developed mixture of the three component system to a temperature equal to or higher than a specific decolorizing temperature Th, decolorization can be instantaneously achieved. Furthermore, even when the decolorized mixture is cooled to a temperature equal to or lower than Th, the decolorized state is maintained. A reversible color developing-decolorizing reaction can be caused in which further decrease of the temperature restore a color development reaction between a leuco dye and a developer at a temperature equal to or lower than a specific recolorizing temperature Tc to thereby return to a color development state. In particular, it is preferable that the decolorizing agent satisfy a relationship of Th>Tr>Tc wherein Tr is a room temperature.

Examples of the decolorizing agent capable of causing the above-mentioned temperature hysteresis may include alcohols, esters, ketones, ethers, and acid amides.

In particular, esters are preferable. Specific examples of the esters may include a carboxylate ester containing a substituted aromatic ring, an ester of a carboxylic acid containing an unsubstituted aromatic ring and an aliphatic alcohol, a carboxylate ester containing a cyclohexyl group in a molecule, an ester of a fatty acid and an unsubstituted aromatic alcohol or phenol, an ester of a fatty acid and a branched aliphatic alcohol, an ester of a dicarboxylic acid and an aromatic alcohol or a branched aliphatic alcohol, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These may be used as a mixture of two or more.

Furthermore, the toner according to the embodiment may contain other components.

For example, examples of other components may include a release agent contained in a toner particle. Examples of the release agent may include: a natural wax such as a rice wax and a carnauba wax; a petroleum wax such as a paraffin wax; and a synthesized wax such as a fatty acid ester, a fatty acid amide, a low molecular weight polyethylene, and a low molecular weight polypropylene.

Also, various charge control agents (CCAs) can be added for the purpose of adjusting electrostatic charges.

Furthermore, as external additives, silica, titanium oxide, alumina, metal soap, and the like can be used.

Also, a method for manufacturing the toner according to the embodiment is not particularly limited, and can be appropriately determined by those skilled in the art. Machines, apparatuses, and the like used for manufacturing are also not particularly limited.

For example, examples of the method for manufacturing a toner may include a kneading and pulverizing method. In the kneading and pulverizing method, a binder resin, a color-forming compound that is a colorant, a developer, and the like are mixed in a uniform manner, and the mixture are kneaded and cooled. Thereafter, the obtained product is subjected to pulverization and classification into a predetermined size to thereby configure a toner particle of approximately 4 to 20 μm. Then, an external additive is attached to the toner particle as necessary, and the obtained product is mixed using a mixer such as a Henschel mixer. Also, the toner according to the embodiment can be manufactured by a chemical method, in which a toner particle prepared by emulsifying and dispersing particulates of constituent materials in water and thereafter aggregating the obtained product are subjected to heating and fusion, and filtration and drying.

When a cellulose fiber is an aspect contained in a toner particle, in the case that a toner is manufactured by a kneading and pulverizing method, for example, the cellulose fiber is mixed with a binder resin and the like, and then the mixture is contained in a toner particle.

Also, when a cellulose fiber is attached to a toner particle, similarly to an external additive, the cellulose fiber can be mixed with a toner particle, so that the cellulose fiber is attached to a toner particle.

The toner according to the embodiment can be installed in an image forming apparatus such as, for example, an MFP (Multi Function Peripheral) as a one-component system developer or a two-component system developer that is non-magnetic, so as to be used in image forming on a sheet of paper in an electrophotographic system. When used as a two-component developer, a usable carrier is not particularly limited, and may be appropriately determined by those skilled in the art.

In an image forming process, a toner image formed by the toner according to the embodiment and transferred on a sheet of paper is heated at a fixing temperature. As a result, a binder resin is melted to permeate a sheet of paper so that the resin thereafter solidifies, thereby forming an image on a sheet of paper (a fixing treatment).

Also, the image formed on a sheet of paper can be erased by performing a decolorizing treatment of the toner. A concrete example of the decolorizing treatment may include heating a sheet of paper, on which an image has been formed, at a heating temperature equal to or higher than the decolorizing temperature to thereby dissociate a color-forming compound and a developer which have been bonded together.

As described above, according to the toner of the embodiment, it is possible that the boundary between a sheet of paper and a toner component remained on the sheet of paper becomes difficult to be recognized. For this reason, since the image erased by a decolorizing treatment becomes difficult to be recognized even after the sheet of paper has been repeatedly used, the number of times a sheet of paper can be recycled may be increased.

The toner according to the embodiment will be described in more detail with reference to the examples below. However the embodiment is not limited by the examples.

### <Preparation of Encapsulated Decolorizable Colorant Particles>

Components including 1 part by mass of 3-(2-ethoxy-4-diethylaminophenyl) -3-(1-ethyl-2-methylindole-3-yl)-4-azaphthalide as a leuco dye, 5 parts by mass of 2,2-bis (4-hydroxyphenyl)hexafluoropropane as a developer, and 50 parts by mass of a diester compound of a pimelic acid and 2-(4-benzyloxyphenyl)ethanol as a decolorizing agent were heated and dissolved. Furthermore, the dissolved mixture, and a solution, in which 20 parts by mass of an aromatic polyvalent isocyanate prepolymer as an encapsulated agent and 40 parts by mass of ethyl acetate were mixed, was introduced in 250 parts by mass of an 8% aqueous solution of polyvinyl alcohol, and then emulsified and dispersed. The dispersion was stirred at 90° C. for approximately 1 hour. Thereafter, 2 parts of a water-soluble aliphatic modified amine as a reactant were added, and the mixture was further stirred for approximately 3 hours while the liquid temperature was maintained at 90° C., to thereby obtain colorless encapsulated particles. Furthermore, the capsule particle dispersion was placed in a freezer for color development. Then, the dispersion was subjected to solid-liquid separation and dried, to thereby obtain blue coloring particles A.

The coloring particles A were measured using SALD7000 manufactured by Shimazu Corporation. The volume average particle diameter was 2 μm. Also, the complete decolorization temperature Th was 79° C., and the complete color development temperature Tc was −10° C.

### <Preparation of Cellulose Fiber>

A commercially available wood pulp was cut, and the pieces of wood pulp were stirred in water using a mixer for 5 minutes. Then, the obtained product was stirred using a high speed rotating homogenizer for 30 minutes to thereby obtain cellulose fibers having an average long diameter of 10 μm. The obtained cellulose fibers were washed and dried, and then used for manufacturing a toner.

### Example 1

Each raw material was weighed to obtain the following formula:

| | |
|---|---|
| Polyester resins (Tg 55° C.) | 55 parts by weight |
| Rice wax | 5 parts by weight |
| Coloring particles A | 10 parts by weight |
| Cellulose fibers | 30 parts by weight |

The materials in the above-mentioned formula were weighted, and mixed in a uniform manner using a Henschel mixer. Then, the mixture was kneaded using a biaxial kneader in which the temperature was set at 80° C. The kneaded toner composition was cooled on a belt cooler, and then roughly cracked into 2 mm or less using a hammer mill. The cracked product ran through a pneumatic mill and classifier to prepare particles having an average particle size of 10 μm. Furthermore, 2 parts by weight of hydrophobic silica and 0.5 parts by weight of titanium oxide were added, and mixed using a Henschel mixer. Thereafter, the mixture passed through a sieve of mesh #200 to thereby obtain a toner. Since the prepared toner is decolorized by heat due to kneading, the toner was retained in a freezer at −20° C. for two days for cooling so that color redevelopment was caused.

In observation of the obtained toner using an SEM, it was confirmed that a fibrous substance exists on the periphery of an interface of a toner particle. Thus, it could be confirmed that cellulose fibers were still remained. Also, soxhlet extraction was performed with a mixed solvent of ethanol and benzene (ethanol:benzene=1:2), and it was confirmed from half quantity test data of an unmelted residual component that the introduced amount was almost remained in the toner. Also, it could be identified from FT-IR. that the residual component was cellulose.

The obtained toner was mixed with a ferrite carrier coated with a silicon resin, and loaded into a K-developing unit of an MFP (e-Studio4520C) manufactured by Toshiba Tec Corporation for image evaluation. The temperature of a fixing unit of the MFP was set at 85° C.

The image density of the obtained image was measured using a Macbeth image densitometer RD-918. The measured value was 0.50, and image failure or fixing failure was not particularly observed. Also, by passing this image through the fixing unit set at 110° C., a blue color of the image disappeared, and the image density became 0.08.

This sheet of paper was used again to repeat the operation of a printing and erasing treatment using the toner according to Example 1.

A limit sample was employed as a reference to determine the number of times a sheet of paper can be recycled.

Specifically, first, a reference toner (a toner of Comparative example 1) was used to form and erase an image of the chart in which reference letters were used. This process was repeated multiple times to prepare a plurality of image samples . As a reference toner, the toner of Comparative example 1 described later was employed. Here, reference letters refer to alphabetic characters, katakana characters, and symbols which are 8 bit system (ASCII); alphabetic characters, katakana characters, and symbols of 16 bit system (JIS); hiragana characters and Chinese characters of 16 bit system (JIS); and the like. Of the prepared image samples, the image at the number of times in which a human began to recognize that the image has not been erased completely and remained was used as a reference sample for comparison. Selection of the limit samples was performed not only by a designer but by 10 members including persons in charge of quality assurance and services. The limit sample was used also in other examples and comparative examples in order to determine the number of times a sheet of paper can be recycled.

The operation of a printing and decolorizing treatment using the toner according to Example 1 was repeated ten times. However, a trace of the toner remained on a sheet of paper was not particularly remarkable, and the sheet of paper could be recycled again.

### Comparative Example 1

| | |
|---|---|
| Polyester resins (Tg 55° C.) | 85 parts by weight |
| Rice wax | 5 parts by weight |
| Coloring particles A | 10 parts by weight |

A toner was prepared and evaluated in the same manner as in Example 1, except that a cellulose fiber was not used. The image density when printed was 0.49, and image failure and fixing failure were not particularly observed. Also, by passing the image through a fixing unit in which the temperature was set at 110° C., a blue color of the image disappeared, and the image density became 0.08.

This sheet of paper was used again to repeat the operation of a printing and decolorizing treatment using the toner according to Comparative example 1. In this case, when the operation was repeated five times, a trace of the toner component remained on a sheet of paper became remarkable, and even after performing a decolorizing treatment, the printed image became recognizable. Since the remaining image was easier to be recognized than that of the limit sample, it was determined that the number of times a sheet of paper can be recycled was five.

### Example 2

| | |
|---|---|
| Polyester resins (Tg 55° C.) | 35 parts by weight |
| Rice wax | 5 parts by weight |
| Coloring particles A | 10 parts by weight |
| Cellulose fibers | 50 parts by weight |

A toner was prepared and evaluated in the same manner as in Example 1, except that the amount of cellulose fibers was 50 parts by mass and the amount of polyester resins was 35 parts by weight. The obtained initial image density was 0.49, and image failure was not particularly observed. However, peeling was caused when the image portion was rubbed with a nail. Also, by passing the image through a fixing unit in which the temperature was set at 110° C., a blue color of the image disappeared, and the image density became 0.08.

This sheet of paper was used again to repeat the operation of a printing and decolorizing treatment using the toner according to Example 2. Even after the operation was repeated ten times, a trace of the toner remained on a sheet of paper was not particularly remarkable, and the paper could be recycled again.

### Example 3

| | |
|---|---|
| Polyester resins (Tg 55° C.) | 70 parts by weight |
| Rice wax | 5 parts by weight |
| Coloring particles A | 10 parts by weight |
| Cellulose fibers | 15 parts by weight |

A toner was prepared and evaluated in the same manner as in Example 1, except that the amount of cellulose fibers was 15 parts by mass and the amount of resins was 70 parts by mass .

The obtained initial image density was 0.51, and image failure and fixing failure were not particularly observed. Also, by passing the image through a fixing unit in which the temperature was set at 110° C., a blue color of the image disappeared, and the image density became 0.08.

This sheet of paper was used again to repeat the operation of a printing and decolorizing treatment using the toner according to Example 3. In this case, when the operation was repeated eight times, the printed image became recognizable even after performing a decolorizing treatment. Since the remaining image was easier to be recognized than that of a limit sample, it was determined that the number of times a sheet of paper can be recycled was eight.

While certain embodiments have been described, these embodiments have been presented by way of example only, and are not intended to limit the scope of invention. Indeed, the novel toner and method described herein may be embodied in a variety of other forms; furthermore, various omissions, substitutions and changes in the form of the toner and method described herein may be made without departing from the spirit of the inventions. The accompanying claims and their equivalents are intended to cover such forms or modifications as would fall within the scope and spirit of the inventions.

As described in detail above, according to the technology described herein, there can be provided a technology which can improve the number of times a sheet of paper can be recycled.

What is claimed is:

1. An electrophotographic toner which can be decolorized, comprising:
toner particles containing a binder resin, a color-forming compound, and a developer; and
a cellulose fiber which is contained in the toner particles or is attached to the toner particles.

2. The electrophotographic toner according to claim 1, wherein the cellulose fiber is contained in the toner particles.

3. The electrophotographic toner according to claim 1, wherein a ratio of the cellulose fiber to an entire amount of the toner is equal to or higher than 3% by mass.

4. The electrophotographic toner according to claim 1, wherein a ratio of the cellulose fiber to an entire amount of the toner is equal to or higher than 15% by mass.

5. The electrophotographic toner according to claim 1, wherein the cellulose fiber has a size equal to or higher than 0.1 μm and equal to or lower than 10
